(19) United States
(12) Patent Application Publication
(10) Pub. No.: US 2009/0066665 A1
(43) Pub. Date: Mar. 12, 2009

(54) Device and Method for Driving a Touch Pad

(75) Inventor: In Wook LEE, Yongin-si (KR)

Correspondence Address: FENWICK & WEST LLP, SILICON VALLEY CENTER, 801 CALIFORNIA STREET, MOUNTAIN VIEW, CA, 94041, US

(73) Assignee: LEADIS TECHNOLOGY, INC., Sunnyvale, CA (US)

(21) Appl. No.: 12/141,646

(22) Filed: Jun. 18, 2008

(30) Foreign Application Priority Data
Sep. 11, 2007 (KR) 10-2007-0092249

(51) Int. Cl. G06F 3/041

(52) U.S. Cl. 345/173

(57) ABSTRACT

Provided are a device for driving a touch pad, including: an input unit that receives an electrical signal be touching from channels of the touch pad; and a control logic unit that scans the channels. The control logic unit includes a channel selection section which divides the touch pad into a plurality of regions and selects the channels which are to be scanned, wherein the ration of the number of total channels to the number of channels to be scanned is different according to each of the plurality of divided regions. In accordance with the present invention, the scanning speed of the touch pad is improved and, thereby, the response speed of other elements which are operated depending on whether the touch pad is touched or not is enhanced.

### CROSS-REFERENCE TO RELATED APPLICATION

This patent application claims priority under 35 U.S.C. §119(a) from Republic of Korea Patent Application No. 10-2007-0092249, filed on Sep. 11, 2007, which is incorporated by reference herein in its entirety.

### BACKGROUND

1. Technical Field

The present invention relates to a device and a method for driving a touch pad, and more specifically, to a structure of an integrated circuit for driving a touch pad, which does not scan all channels at an n-th scan, but scans all channels only for a region touched at the (n-1)th scan and the neighboring region thereof, and selects and scans only one channel among a plurality of channels for the other regions, and a method for driving the touch pad. The device can improve the scanning speed and the response speed of elements such as LED (light emitting diode), actuator, and audio which operate by inputting an output from the touch pad.

2. Description of the Related Art

Typically, a touch pad is a peripheral device installed on a display surface of a display device such as CRT (cathode ray tube), LCD (liquid crystal display), FED (field emission display), PDP (plasma display panel), or EL (electro luminescence) element. When a user presses the touch panel while seeing the display device, predetermined information is input to a computer.

The touch pad for inputting a signal on a display surface of a display device without a remote control or a separate input device is widely used to use various electronic apparatuses effectively. That is, the touch pad is installed on a display surface of an image display device such as an electronic scheduler, a flat display device (LCD, PDP, EL, or the like), or CRT. Therefore, when a user presses the display surface of the image display device with a pen or a finger, information corresponding to the touched position of the touch pad is input.

Such a touch pad is classified into a resistive type touch pad, a capacitive type touch pad, an electromagnetic type touch pad, and so on.

Among the touch pads, the capacitive type touch pad has a basic structure in which a film having a transparent electrode formed thereon is installed on a liquid crystal panel, and a voltage is applied to each corner of the film such that a uniform magnetic field is generated on the transparent electrode. When a finger or a conductive stylus is contacted with the transparent electrode, a voltage drop occurs so that the coordinate of the touched position is found.

Generally, a semiconductor chip for driving a touch pad reads out the quantity of transmitted charges depending on whether the touch pad is touched or not, and then determines whether a particular terminal of the touch pad is touched or not. Then, the semiconductor chip processes the data.

The touch pad may be divided into a plurality of regions having channels. While scanning the channels, the touch pad detects the change in electrostatic capacity of each channel so as to determine whether a particular position is touched or not. This scanning process should be performed for all the channels. Therefore, the scanning process takes a lot of time. This time consumption results in a reduction in response speed of elements connected to the touch pad, because it should be performed depending on whether the touch pad is touched or not.

The above information disclosed in this Background section is only for enhancement of understanding of the background of the invention and therefore it may contain information that does not form the prior art.

### SUMMARY OF THE DISCLOSURE

An advantage of the present invention is that it provides a device and a method for driving a touch pad, which improves the scanning speed of the touch pad, thereby enhancing the response speed of other elements which are operated depending on whether the touch pad is touched or not. More specifically, when channels of the touch pad are scanned, all the channels are not scanned, but one channel among a plurality of channels is selected and scanned so as to roughly grasp the touched position. Then, at the next scan, all the channels of the position grasped at the primary scan are scanned. For the other regions, one channel is selected from a plurality of channels so as to be scanned, in a manner similar to the primary scan. Therefore, it is possible to reduce the scanning time, compared with when all the channels are scanned, and, thereby, the response speed of other elements which are operated depending on whether the touch pad is touched or not is improved.

In one aspect, the present invention provides a device for driving a touch pad, comprising: an input unit that receives an electrical signal by touching from channels of the touch pad; and a control logic unit that scans the channels. The control logic unit includes a channel selection section which divides the touch pad into a plurality of regions and selects the channels which are to be scanned, wherein the ratio of the number of total channels to the number of channels to be scanned is different according to each of the plurality of divided regions.

In another aspect, the present invention provides a method for driving a touch pad, comprising the steps of: receiving an electrical signal by touching from channels of the touch pad; at a channel selection unit of a control logic unit, dividing the touch pad into a plurality of regions; and scanning channels by varying the ratio of the number of total channels to the number of channels to be scanned according to each of the plurality of divided regions.

According to the invention, when the channels of the touch pad are scanned, the data on which position of the touch pad is touched is analyzed. Then, the channels of the touched position are scanned finely, and the channels of the other region are scanned coarsely or partially. Therefore, it is possible to increase the scanning speed and, thereby, improve the response speed of other elements which are operated depending on whether the touch pad is touched or not.

### BRIEF DESCRIPTION OF THE DRAWINGS

The above and other objects, features and other advantages of the present invention will be more clearly understood from the following detailed description taken in conjunction with the accompanying drawings.

FIG. 1 is a diagram showing the connection relationship between a touch pad and a touch pad driving device according to the invention.

FIG. 2 is a circuit diagram of a touch pad driving device.

FIG. 3 is a graph showing changes in electric charge depending on the operation intervals of first and second capacitors of a touch pad driving device.

FIG. 4A is a diagram showing a method for scanning channels of a touch pad according to a first embodiment.

FIG. 4B is a diagram showing a method for scanning channels of a touch pad according to a second embodiment.

FIG. 4C is a diagram showing a method for scanning channels of a touch pad according to a third embodiment.

FIG. 4D is a diagram showing a method for scanning channels of a touch pad according to a fourth embodiment.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations and shapes will be determined in part by the particular intended application and use environment.

In the figures, like reference numerals refer to the same or equivalent parts of the present invention throughout.

### DETAILED DESCRIPTION OF EMBODIMENTS

Hereinafter, reference will be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined in the appended claims.

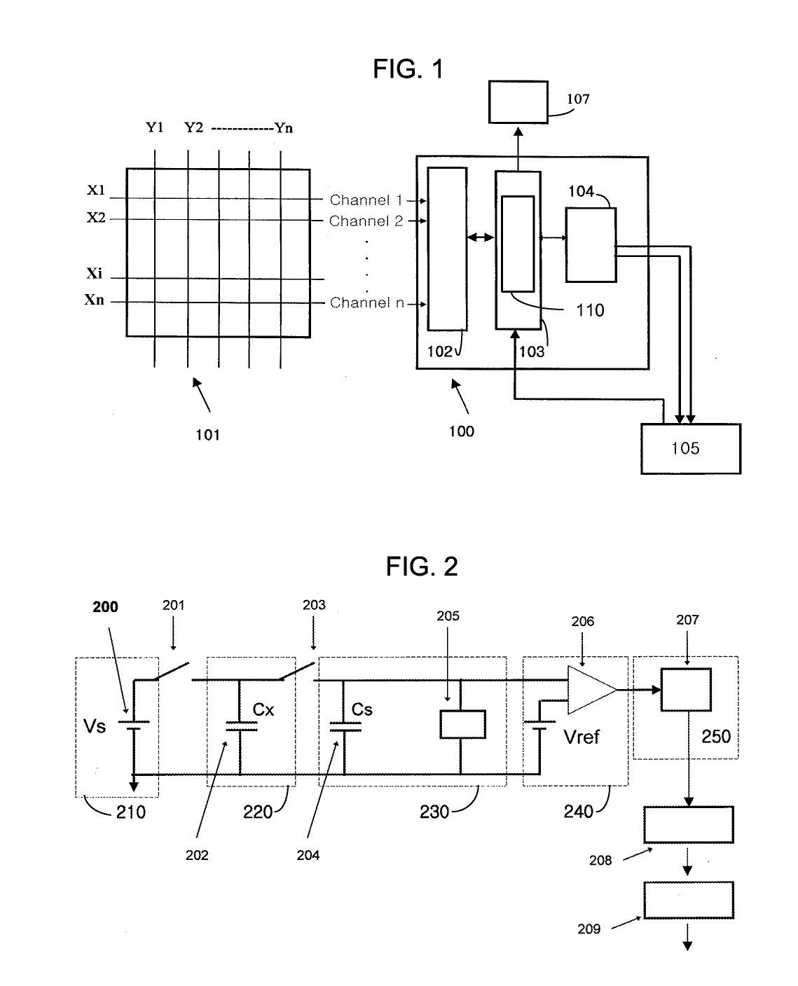

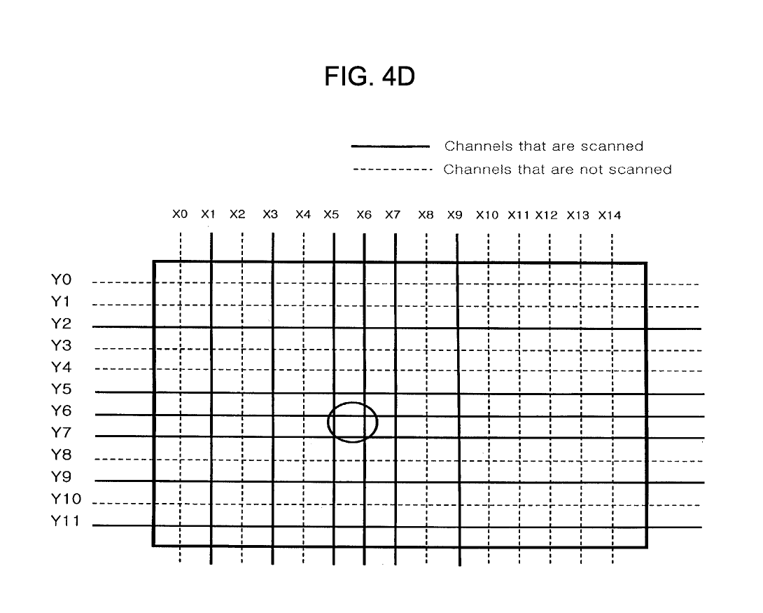

First, the basic operation principle of a touch pad and a touch pad driving chip will be described with reference to FIGS. 1 to 3. Then, the present invention will be described with reference to FIG. 4A to 4D.

The connection relationship between a touch pad and a touch pad driving device according to the invention is shown in FIG. 1. That is, FIG. 1 is a diagram showing the connection relationship between a touch pad and a touch pad driving device. The connection relationship will be described referring to FIG. 1.

The touch pad 101 has a plurality of channels provided in the horizontal and vertical axes thereof, respectively. When a horizontal channel Xi is selected, a capacitance-to-digital converter (CDC) 102 of the touch pad driving device 100 determines whether the touch pad 101 is touched or not, while the vertical channels Y0 to Yn are scanned sequentially. Further, when a horizontal channel Xi+1 is selected, the CDC 102 determines whether the touch pad 101 is touched or not, while the vertical channels Y0 to Yn are scanned sequentially.

A touch at the intersection between a horizontal channel Xi and a vertical channel Yi results in a change of the quantity of electric charge of capacitance there. While the corresponding channels are scanned by the touch pad driving device 100, the CDC 102 of the touch pad driving device 100 detects the change in electric charge so as to determine whether the touch pad 101 is touched or not. The touch information is stored in SRAM 104 along with the positional information on the touch pad, and is then transmitted to an audio device, a haptic unit, a light source 107, and so on such that they are operated. Further, a microprocessor unit (MPU) 105 controls the touch pad driving device 100 and other elements.

A control logic unit 103 controls the above-described process. As an electrical signal is inputted from the channels of the touch pad 101, it is determined whether the touch pad is touched or not, and the touch information and the positional information of the touch pad are stored together and are then outputted to other elements connected to the control logic unit 103.

The control logic unit 103 includes a channel selection section 110 which divides the touch pad into a plurality of regions, when scanning the channels of the touch pad 101 horizontally or vertically, and determines channels selected during the scanning in each region such that a different number of channels are scanned selectively for each region.

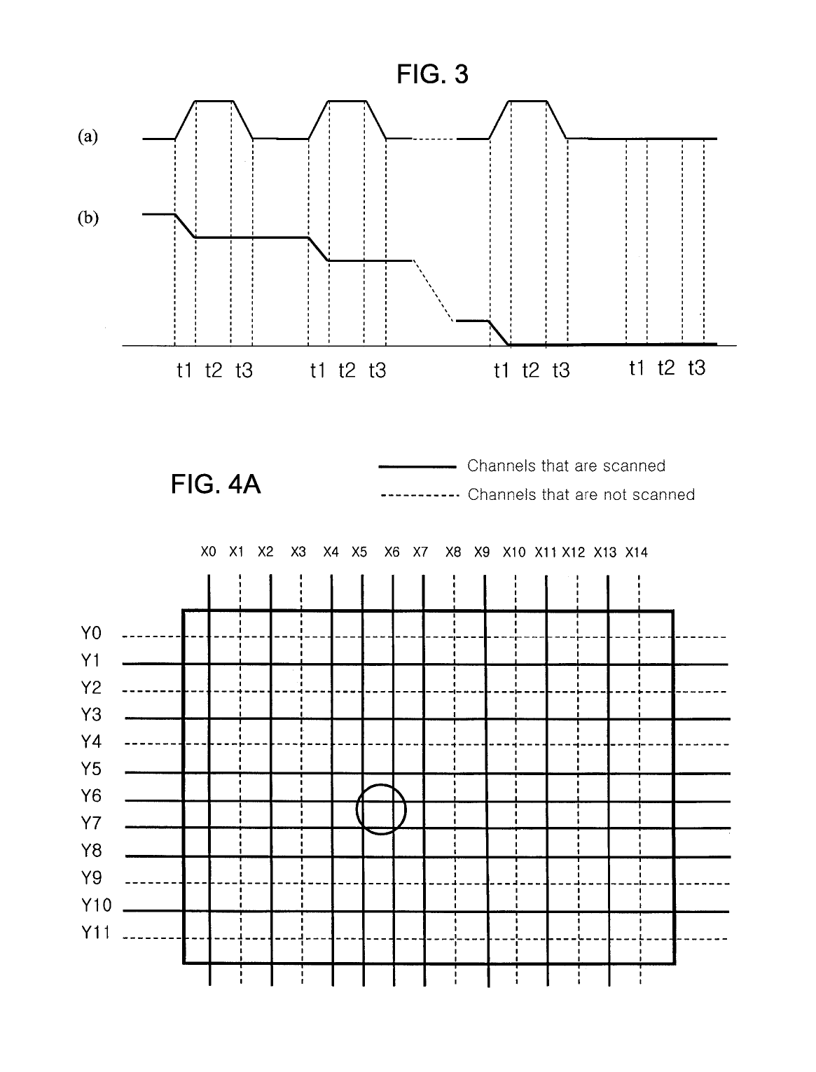

The touch information is high or low values that are outputted from the CDC 102. For example, if the touch pad 101 is touched, the CDC 102 output a high value. If the touch pad 101 is not touched, the CDC 102 output a low value. This will be described in detail with FIG.2.

FIG. 2 is a circuit diagram of the touch pad driving device 100. Referring to FIG. 2, a process in which the touch pad driving device 100 determines whether a certain point of the touch pad connected to a channel is touched or not will be described.

As shown in FIG. 2, the touch pad driving device 100 includes a first capacitor 202, a second capacitor 204, and first and second switches 201 and 203 which are connected to the first and second capacitors 202 and 204, respectively, so as to control the operation of the first and second capacitors 202 and 204. The first and second capacitors 202 and 204 are connected in parallel.

The touch pad driving device 100 further includes a discharge circuit 205 which discharges electric charges stored in the second capacitor 204, a comparator 206 which is connected to the second capacitor 204, a latch unit 207 which is connected to the comparator 206, and a counting unit 208 which is connected to the latch unit 207.

The operation of the above-described components of the touch pad driving device 100 will be described in detail as follows.

When a touch terminal at the intersection between a horizontal channel and a vertical channel is touched, the first capacitor 202 is charged by a voltage source 200 through the first switch 201. Then, the second capacitor 204 is charged through the second switch 203 which is repeatedly opened and closed at predetermined intervals.

After the second switch 203 is closed, the comparator 206 compares the potential of a sensing node between the second capacitor 204 and the comparator 206 with a reference voltage Vref. As a result of the comparison, the comparator 206 outputs a high value in case the touch terminal is determined to be touched.

After the sensing by the comparator 206, the electric charges of the second capacitor 204 are discharged through the discharge circuit 205. Then, when the second switch 203 is closed again, the second capacitor 204 is charged again.

As such, the charging/discharging process of the second capacitor 204 is performed repeatedly, while being synchronized with the process where the second switch 203 is opened and closed repeatedly. Accordingly, until all the electric charges of the first capacitor 202 are charged into the second capacitor 204 so as to be discharged, the comparator 206 outputs high values, which are stored in latch unit 209.

Further, a reference charge charging unit (not shown) is provided, which charges the first capacitor 202 with a reference charge. At the initial stage of the operation of the touch pad driving device, the reference charge charging unit charges the first capacitor 202 with electric charges. After that, while the second switch 203 is opened and closed repeatedly, the comparator 206 compares the potential of the sensing node between the second capacitor 204 and the comparator 206 with the reference voltage Vref so as to output high/low values repeatedly.

The counting unit 208 counts the number of high or low values, and determines whether the touch terminal is touched or not, depending on the number of low/high values. The information whether the touch terminal is touched or not is stored in the SRAM 104 along with the positional information of the touch terminal. Then, the information is outputted and used for operating other elements.

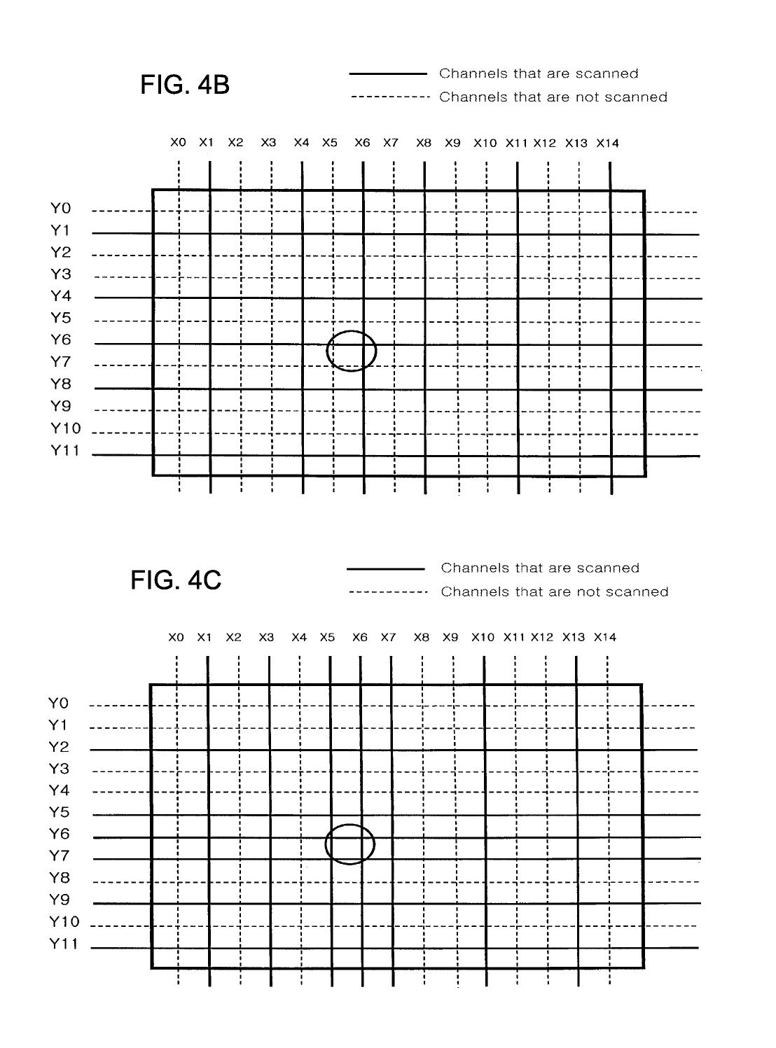

FIG. 3 is a graph showing changes in electric charge depending on the operation intervals of the fist and second capacitors of the touch pad driving device. FIG. 3 shows how the quantities of electric charges stored in the first and second capacitors are changed in the above-described repetition process. Of the two curved lines indicating state changes in FIG. 3, the lower curved line (b) indicates changes in electric charge of the first capacitor 202 (FIG. 2), and the upper curved line (a) indicates changes in electric charge of the second capacitor 204 (FIG. 2).

As indicated by the lower curved line (b) of FIG. 3, while the second switch 203 is opened and closed repeatedly, the first capacitor 202 supplies the electric charges to the second capacitor 204 such that the quantity of electric charges of the first capacitor 203 decreases continuously. However, as indicated by the upper curved line (a) of FIG. 3, while the second switch 203 is closed, the second capacitor 204 receives the electric charges from the first capacitor 202 so as to be charged. After the voltage of the sensing node is sensed by the comparator 206, the second capacitor 204 is discharged by the discharge circuit 205. In this way, the second capacitor 204 is charged and discharged repeatedly.

Now, the invention will be described in detail, focusing on the connection relationship between the touch pad and the touch pad driving device and the operation thereof.

FIGS. 4A to 4D are diagrams showing a method for scanning channels of a touch pad according to embodiments of the invention.

A first embodiment of the invention is shown in FIG. 4A. In the touch standby mode, while one channel is selected from n channels so as to be scanned, the touch information of each position is stored in the SRAM 104. The touch pad 101 includes a fine region and a coarse region. The control logic unit 103 analyzes the touch information of the touched position stored in the SRAM 104 so as to determine which position is touched at a p-th scan. Then, during the (p+1)th scan, the channels of the coordinate (X6, Y6) of the position touched at the p-th scan and the neighboring region (the fine region, X5-X6 and Y6-Y7) are all scanned, and the channels of the other region (the coarse region, X0-X4, X7-X14, Y0-Y5, and Y8-Y11) are scanned while one channel is skipped for every n channels (n=2 in the embodiment of FIG. 4A). Therefore, it is possible to improve the scanning speed, compared with when all the channels are scanned.

Subsequently, when it is detected at the (p+1)th scan that the touched position is changed to a coordinate (Xi+1, Yi+1), the channels of the coordinate (Xi+1, Yi+1) and the neighboring region thereof are designated as the fine region at the (p+2)th scan such that all the channel of the fine region are scanned. The channels of the other regions (coarse regions) are scanned while one channel is selected for every n channels.

At this time, the channel selection section 110 of the control logic unit 103 determines to which neighboring region from the touched position (Xi, Yi) the channels should be scanned at the same frequency as that of the touched position (Xi, Yi). That is, the setting of the fine region is performed by the channel selection section 110 of the control logic unit 103.

A second embodiment of the invention is shown in FIG. 4B. As shown in FIG. 4B, when a neighboring region including the coordinate (X6, Y6), that is, the fine region (X4-X8 and Y4-Y8) is scanned, all the channels are not scanned, but m channels (m=1) are selected from every n channels (n=2) so as to be scanned. For the coarse region (X0-X3, X9-X14, Y0-Y3, and Y9-Y11), k channels (k=1) are selected from every j channels (j=3) so as to be scanned. Here, the relationships n>m, j>k, and m/n>k/j are satisfied. That is, even in the fine region, all the channels are not selected, but some of the channels are selected. However, the scanning in the fine region is performed more finely than in the coarse region.

A third embodiment of the invention is shown in FIG. 4C. As shown in FIG. 4C, when the coarse region is scanned, the scanning is performed with a plurality of scanning frequencies. That is, for some regions (X0-X4, Y0-Y4, and Y8-Y10) of the coarse region, k channels (k=1) are selected from every j channels (j=2). For the other regions (X8-X14, Y0-Y4, and Y8-Y11) of the coarse region, i channels (i=1) are selected from every h channels (h=3) so as to be scanned. Here, the relationships j>k, h>i, and k/j>i/h are satisfied. That is, the scanning frequency in the coarse region is diversified to improve the scanning speed.

A fourth embodiment of the invention is shown in FIG. 4D. As shown in FIG. 4D, channels are not selected in some regions (X11-X14, Y0-Y4, and Y8-Y11) of the coarse region divided into a plurality of regions such that the scanning is not performed (in a case of i=0).

The method for driving a touch pad according to the fourth embodiment, in which some regions of the touch pad are controlled in such a manner that scanning is not performed in the regions, can be expanded into a method in which some channels of a specific region of the touch pad are controlled so as not to be scanned. Therefore, even when the number of channels of the touch pad is changed, the touch pad can be driven without having to change the touch pad driving device, which makes it possible to enhance the universality of the touch pad driving device. This process is also controlled by the channel selection section 110 of the control logic unit 103.

The fine region and the coarse region may be determined at the previous scan, depending on which position is touched. However, based on the touch frequency for each region, a user may control the channel selection section 110 so as to determine a fine region and a coarse region arbitrarily.

While the present invention has been described with reference to exemplary embodiments thereof, it will be understood by those skilled in the art that various changes and modifications in form and detail may be made therein without departing from the scope of the present invention as defined by the following claims.

What is claimed is:

1. A device for driving a touch pad, comprising:
an input unit that receives an electrical signal by touching from channels of the touch pad; and
a control logic unit that scans the channels,
wherein the control logic unit comprises a channel selection section which divides the touch pad into a plurality of regions and selects the channels which are to be scanned, and the ratio of the number of total channels to the number of channels to be scanned is different according to each of the plurality of divided regions.

2. The device according to claim 1,
wherein the touch pad includes a fine region and a coarse region, and
the channel selection section selects m channels from n channels in the fine region and selects k channels from j channels in the coarse region, where n, m, j, and k are natural numbers, and the relationships n≧m, j≧k, and m/n>k/j are satisfied.

3. The device according to claim 1,
wherein the touch pad includes a fine region and a coarse region, and
the channel selection section divides the coarse region into a plurality of regions, selects m channels from n channels in the fine region, selects k channels from j channels in some regions of the coarse region, and selects i channels from h channels in the other regions of the coarse region, where n, m, j, k, h, and i are natural numbers, and the relationships n >m,j>k, h>i and m/n>k/j>i/hare satisfied.

4. The device according to claim 1,
wherein the touch pad includes a fine region and a coarse region, and
the channel selection section divides the coarse region into a plurality of regions, selects m channels from n channels in the fine region, selects k channels from j channels in some regions of the coarse region, and selects i channels from h channels in the other regions of the coarse region, where n, m, j, k, and h are natural numbers, i is 0, and the relationships n≧m, j>k, and m/n>k/j are satisfied.

5. The device according to claim 2,
wherein when the channel selection section divides the touch pad into a plurality of regions, a neighboring region including a position touched at a previous scan is designated as the fine region, and the other region excluding the fine region is designated as the coarse region.

6. The device according to claim 3,
wherein when the channel selection section divides the touch pad into a plurality of regions, a neighboring region including a position touched at a previous scan is designated as the fine region, and the other region excluding the fine region is designated as the coarse region.

7. The device according to claim 4,
wherein when the channel selection section divides the touch pad into a plurality of regions, a neighboring region including a position touched at a previous scan is designated as the fine region, and the other region excluding the fine region is designated as the coarse region.

8. The device according to claim 1, further comprising:
a capacitance-to-digital converter (CDC) unit that outputs high or low values according to the electrical signal; and
a memory unit that stores the values outputted from the CDC unit and positional information of the touch pad.

9. A method for driving a touch pad, comprising the steps of:
receiving an electrical signal by touching from channels of the touch pad;
at a channel selection unit of a control logic unit, dividing the touch pad into a plurality of regions; and
scanning channels by varying the ratio of the number of total channels to the number of channels to be scanned according to each of the plurality of divided regions.

10. The method according to claim 9,
wherein the touch pad includes a fine region and a coarse region, and
in the scanning of the channels, the control logic unit selects m channels from n channels in the fine region and selects k channels from j channels in the coarse region and scans the selected channels, where n, m, j, and k are natural numbers, and the relationships n≦m, j>k, and m/n>k/j are satisfied.

11. The method according to claim 9,
wherein the touch pad includes a fine region and a coarse region, and
in the scanning of the channels, the control logic unit divides the coarse region into a plurality of regions, selects m channels from n channels in the fine region, selects k channels from j channels in some regions of the coarse region, and selects i channels from h channels in the other regions of the coarse region and scans the selected channels, where n, m, j, k, h, and i are natural numbers, and the relationships n≧m, j>k, h>i and m/n>k/j>i/h are satisfied.

12. The method according to claim 9,
wherein the touch pad includes a fine region and a coarse region, and
in the scanning of the channels, the control logic unit divides the coarse region into a plurality of regions, selects m channels from n channels in the fine region, selects k channels from j channels in some regions of the coarse region, and selects i channels from h channels in the other regions of the coarse region and scans the selected channels, where n, m, j, k, and h are natural numbers, i is 0, and the relationships n≧m, j>k, and m/n>k/j are satisfied.

13. The method according to claim 10,
wherein in said dividing the touch pad into a plurality of regions, when the channel selection section divides the touch pad into a plurality of regions, a neighboring region including a position touched at a previous scan is designated as the fine region, and the other region excluding the fine region is designated as the coarse region.

14. The method according to claim 11,
wherein in said dividing the touch pad into a plurality of regions, when the channel selection section divides the touch pad into a plurality of regions, a neighboring region including a position touched at a previous scan is designated as the fine region, and the other region excluding the fine region is designated as the coarse region.

15. The method according to claim 12,
wherein in said dividing the touch pad into a plurality of regions, when the channel selection section divides the touch pad into a plurality of regions, a neighboring region including a position touched at a previous scan is designated as the fine region, and the other region excluding the fine region is designated as the coarse region.

16. The method according to claim 9, further comprising the steps of:
outputting high or low values according to the electrical signal from a capacitance-to-digital converter (CDC) unit; and
storing the values outputted form the CDC unit and positional information of the touch pad into a memory unit.
